(19) United States
(12) Patent Application Publication
(10) Pub. No.: US 2011/0097187 A1
(43) Pub. Date: Apr. 28, 2011

(54) VEHICLE GUIDANCE SYSTEM FOR AUTOMOTIVE LIFTS

(75) Inventors: Brian E. Kelley, Madison, IN (US); Robert W. Elliott, Madison, IN (US)

(73) Assignee: VEHICLE SERVICE GROUP, LLC, Madison, IN (US)

(21) Appl. No.: 12/971,203

(22) Filed: Dec. 17, 2010

Related U.S. Application Data
(63) Continuation of application No. PCT/US2009/049368, filed on Jul. 1, 2009.
(60) Provisional application No. 61/077,913, filed on Jul. 3, 2008.

(51) Int. Cl. B66F 7/00

(52) U.S. Cl. 414/814; 187/203

(57) ABSTRACT

A vehicle lift system comprises a vehicle lift and one or more laser modules. The vehicle lift includes one or more lifting members that are operable to selectively raise and lower a vehicle. The laser modules are operable to emit at least one laser beam to provide a visual indicator on a vehicle positioned relative to the one or more lifting members. The vehicle lift may include any type of lift. The visual indicator may include a line, crosshairs, target, dot, or anything else, including combinations and patterns. The visual indicator may flash or remain solid. The visual indicator may be any color (e.g., green). One or more sensors may provide activation and/or de-activation of the laser modules in response to sensing the presence of a vehicle. An operator may view the visual indicator on the vehicle to confirm proper positioning of the vehicle relative to the lifting members.

### PRIORITY

This application is a continuation of International Patent Application No. PCT/US2009/049368, entitled “Vehicle Guidance System for Automotive Lifts,” filed Jul. 1, 2009, published as International Pub. No. WO 2010/002968, the disclosure of which is incorporated by reference herein, and which claims priority from the disclosure of U.S. Provisional Patent Application Ser. No. 61/077,913, entitled “Vehicle Guidance System for Automotive Lifts,” filed Jul. 3, 2008, the disclosure of which is incorporated by reference herein.

### BACKGROUND

Some versions of the present invention relate, in general, to vehicle lifts and, more particularly, to vehicle lifts having a guidance system. Among other things, a guidance system may help with positioning a vehicle in a suitable position for engagement with the vehicle lift system. While a variety of systems and configurations have been made and used to operate lift systems, it is believed that no one prior to the inventors has made or used the invention recited in the appended claims.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 shows a top view of an exemplary vehicle lift system;

FIG. 2 shows a top view of an exemplary vehicle lift system;

FIG. 3 shows a top view of the lift system depicted in FIG. 2 engaged with a vehicle;

FIG. 4 shows a side front view of a vehicle lift system; and

FIG. 5 shows a perspective view of a four-column vehicle lift system.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

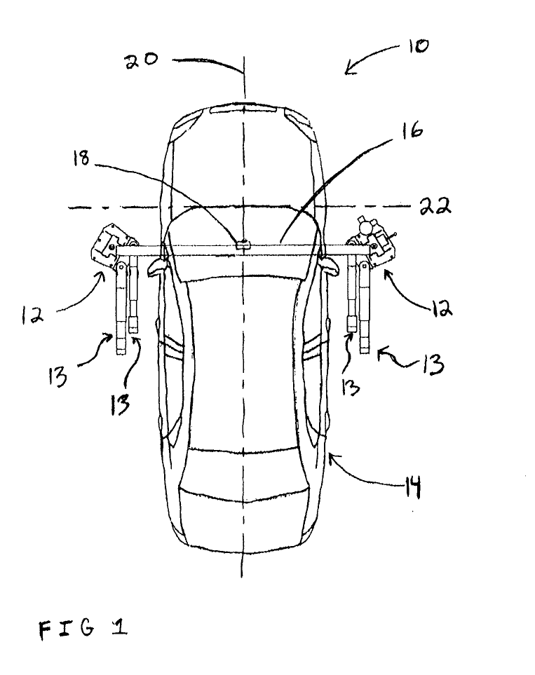

FIG. 1 illustrates an exemplary lift system (10) comprising a plurality of lift columns (12) where the system (10) may selectively serve to lift a vehicle (14) or selectively set the vehicle (14) on the ground. Lift system (10) may comprise an ascent mode and/or a descent mode directed to the columns (12) according to a control system. An ascent and/or descent for all of the columns (12) may be synchronized or coordinated to ensure the stability of the vehicle (14). However, circumstances may exist where only one column (12) or some, but not all, of the columns (12) may otherwise raise or lower the vehicle (14). Other situations may call for raising or lowering columns (12) at different rates, or making corrections to the ascent/descent rates of individual columns (12). Several examples of circumstances surrounding the latter may include, but are not limited to, correcting any height differences or ascent/descent rates between lifting columns (12) or elevating only a certain portion of a vehicle (14).

As noted above, operating lift system (10) may be operable to perform a variety of functions, such as raising and lowering vehicle (14), among other functions. Accordingly, vehicle (14) may be placed in a suitable position between columns (12) prior to the engagement between vehicle (14) and lift system (10). Guiding vehicle (14) to a suitable position between columns (12) may incorporate the use of one or more laser beams. Laser beams may guide vehicle (14) to a suitable position in a variety of ways. For instance, lift system (10) of the present example comprises an overhead member (16). Overhead member (16) comprises an elongated bar. However, any suitable type of overhead member (16) may be used, to the extent that any overhead member (16) is used at all. Yet further, overhead member (16) may consist of any suitable material, including but not limited to metal, plastic, wood, or rubber, etc. Overhead member (16) is engaged with a laser module (18) in the present example. Laser module (18) and overhead member (16) may be engaged in any suitable manner, including but not limited to bolts, adhesives, screws, other fasteners, straps, etc. It should also be understood that the mounting of laser module (18) to overhead member (16) is just one merely illustrative example. For instance, laser module (18) may instead be mounted to a column (12), the ceiling above lift system (10), or in any other suitable location.

In FIG. 1, laser module (18) is positioned approximately equally between columns (12). Laser module (18) is capable of generating a laser beam, such as to emit a laser line (20). Laser line (20) travels in a direction perpendicular to the front and back of vehicle (14) in this example. In particular, laser line (20) runs along the front hood, windshield, top, and back of the car. It should be understood that, because the laser module (18) is positioned approximately equally between columns (12), an operator may use laser line (20) to suitably position the vehicle (14) between columns (12).

Of course, any suitable laser may be used and configured in any suitable manner. For example, a laser module (18) may be placed on a ceiling of a building or any other suitable location, such as the upper portion of a lift column (12) as noted above. Placing a laser module (18) on a ceiling may produce a laser line (22) that travels perpendicular to the sides of vehicle (14) as shown in FIG. 1. Alternatively, a laser module (18) on the ceiling may produce laser line (22) while a laser module (18) on overhead member (16) may produce laser line (20). Other suitable locations for mounting laser modules (18) and other suitable types of laser line orientations that may be provided will be apparent to those of ordinary skill in the art in view of the teachings herein. Of course, a single laser module (18) may also produce more than one laser line. It should also be understood that, while two lasers are used in the present example, any other suitable number of lasers may be used. For example, one laser may be used. Likewise, more than two lasers may be used. Yet further, and among other things, the type of vehicle, the type of lift, and user preference may also affect the configuration of one or more laser modules (18) in relation to the lift system (10).

Having multiple laser lines (20, 22) intersect one another produces a crosshair in the present example. In particular, in the example of FIG. 1, the crosshair is located along the connection of the lower portion of the windshield and hood for vehicle (14) when vehicle (14) is properly positioned relative to columns (12). The crosshair may thus be used as an identification point for suitably positioning vehicle (14). Of course, one or more laser modules (18) may alternatively be configured and/or positioned such that a crosshair is located anywhere else on vehicle (14) is properly positioned relative to columns (12). By way of example only, laser modules (18) could be configured and/or positioned so that vehicle (14) is in a proper position relative to columns (12) when the laser crosshair appears elsewhere on the hood of vehicle (14) (e.g., its center, etc.). As another merely illustrative example, the crosshair may align with the center of the windshield or the side of vehicle (14).

As noted above, any suitable type(s) of laser and/or combinations of lasers may be used. For example, a laser emitting a certain shape or size may be used. Examples may include having a laser emit a continuous line, a broken line, a dot, a series of dots, a crosshair, or some other pattern or combination of patterns. That is, laser module (18) may simply produce a dot instead of a line (20, 22), if desired. Likewise, a plurality of lasers may be positioned to, in combination, produce a line, dot, crosshair, or some other pattern. As another merely illustrative example, a first laser may produce a dot while a second laser produces a line, with the dot overlapping the line or being otherwise positioned relative to the line. As yet another merely illustrative example, a single laser producing just a single laser line may be used. It should also be understood that, when one or more laser modules (18) are activated, they may produce one or more substantially continuous laser beams. In addition or in the alternative, when one or more laser modules (18) are activated, they may produce one or more flashing laser beams. To the extent that one or more flashing laser beams are used, such laser beams may flash in any suitable pattern. Still other suitable visual indicia, patterns of visual indicia, combinations of visual indicia, combinations of patterns of indicia, etc., that may be produced by one or more laser modules (18) in accordance with the teachings herein will be apparent to those of ordinary skill in the art in view of the teachings herein.

It should also be understood that one or more laser modules (18) may generate one or more lasers of any suitable color or colors. By way of example only, a green laser beam may be used. As another merely illustrative example, a red laser beam may be used. As yet another merely illustrative example, one red laser beam may be used and another green laser beam may be used. In some versions, laser beams of two different colors are used, such that they together produce a third color in a region where the two laser beams intersect. Other suitable colors and color schemes for laser beams that are produced by one or more laser modules (18) will be apparent to those of ordinary skill in the art in view of the teachings herein.

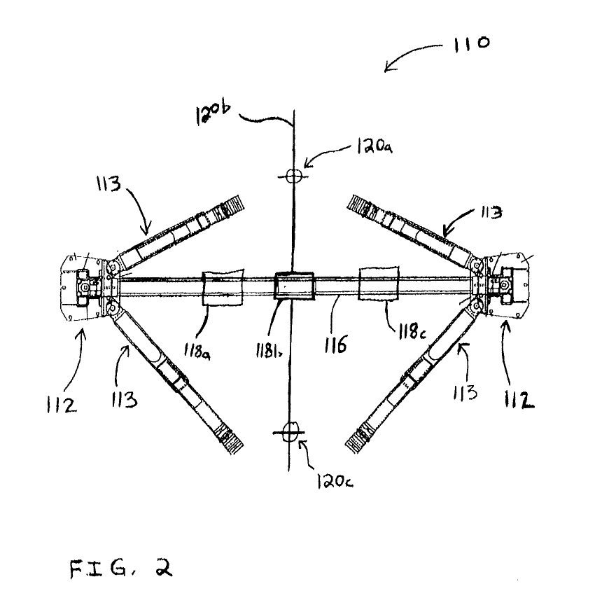

In the example shown in FIG. 1, lift system (10) has two lift columns (12). However, it should be understood that the laser guidance examples described herein (as well as their numerous variations) may be implemented into virtually any other type of lift system. In other words, the inventors to not consider the present invention to be limited to use with any particular type of lift at all, let alone the particular types of lifts explicitly referred to herein. While some other types of lift systems are shown in FIGS. 2-5 and are described in greater detail below, it should be understood that those are merely illustrative and are not intended to be limiting in any way. By way of example only, the laser guidance examples described herein (as well as their numerous variations) may be implemented in vehicle lifts having four lift columns, six lift columns, eight lift columns, any other suitable number of lift columns, lift columns that are fixedly secured to the ground, lift columns that are movable independently relative to the ground (a.k.a. “mobile lifts,” etc.), scissor lifts, parallelogram lifts, lift tables (e.g., collision lift table that uses a rack system to lift the vehicle, etc.) vehicle lifts with one or more overhead members (16), vehicle lifts with no overhead members (16), any type of in-ground lifts, and any type of above-ground lifts, among other types of lifts. Still other suitable types of lifts in which the examples described herein may be implemented will be apparent to those of ordinary skill in the art in view of the teachings herein. Similarly, suitable ways in which the examples described herein may be implemented into such other lifts will be apparent to those of ordinary skill in the art in view of the teachings herein. It should also be understood that, while vehicle (14) is shown as a car, any other suitable type of vehicle may be used, including but not limited to a truck, bus, van, etc. In other words, the inventors to not consider the present invention to be limited to use with any particular type of vehicle at all, let alone a car.

A plurality of types of laser modules are depicted in another merely illustrative example of a lift system (110) shown in FIG. 2. Lift system (110) of this example comprises a plurality of lift columns (112) including arms (113) for supporting a vehicle (not shown). Columns (112) both engage an overhead member (116). Overhead member (116) supports a plurality of laser modules (118a, 118b, 118c). Laser modules (118a, 118c) emit a target shape (120a, 120c); while laser module (118b) emits a line (120b). As should be apparent from the configuration shown in FIG. 2, a vehicle may be suitably positioned for engagement with lift system (110) through a variety of methods. For example, a vehicle may travel into the area between columns (112) by first entering through the area near target sign (120c). The vehicle would then travel under overhead member (116) until appropriately aligned with laser line (120b) and target sign (120a). Alternatively, a vehicle may travel into the area between columns (112) by first entering through the area near target sign (120a) and under overhead member (116). The vehicle would then travel until appropriately aligned with line (120b) and target sign (120c). In some versions, target signs (120a, 120c) are be located such that they are spaced equidistantly from overhead member (116) along line (120b). Alternatively, target signs (120a, 12c) may be located at any other suitable positions relative to overhead member (116) and/or line (120b).

As noted above, laser modules (118a, 118b, 118c) may be located in any suitable position. For example, laser modules (118a, 118b, 118c) may be engaged with overhead member (116) and/or a ceiling (not shown) under which the system (110) is positioned. Further, the placement of the laser modules (118a, 118b, 118c) may be affected by the type of lift system involved (e.g., light duty or heavy duty, etc.), the type of vehicle involved, user preference, and/or a variety of other factors. Laser modules (118a, 118b, 118c) may be configured so the emitted beams appear on the front of the vehicle, the side of the vehicle, the rear of the vehicle and/or another suitable location that provides adequate notice to one or more operators (e.g., an operator of the vehicle and/or the operator of lift system (110), etc.) that the vehicle is in a suitable position to properly engage arms (113) of lift system (110).

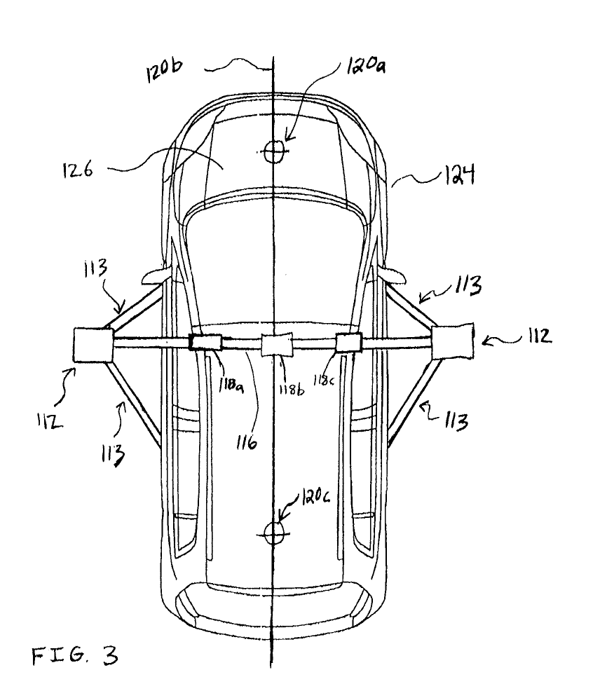

FIG. 3 depicts a vehicle (124) properly positioned relative to the vehicle lift system (110) shown in FIG. 2. As shown in this example, vehicle (124) entered the area between columns (112) by first moving near target sign (120c) emitted by module (118c). Vehicle (124) then traveled beneath overhead member (116) until the middle of its hood (126) aligned with laser line (120b) and target sign (120a). As shown, vehicle (124) is in a suitable position for engagement with arms (113) of lift system (110) when the middle of the hood on vehicle (114) is aligned with laser line (120b) and target sign (120a). Of course, and as noted above, any other suitable type or types of visual indicia may be provided by laser beams emitted by laser modules (118a, 118b, 118c); and such visual indicia may be located in any suitable position(s) relative to vehicle (124) when vehicle is in a suitable position for engagement with arms (113) of lift system (110).

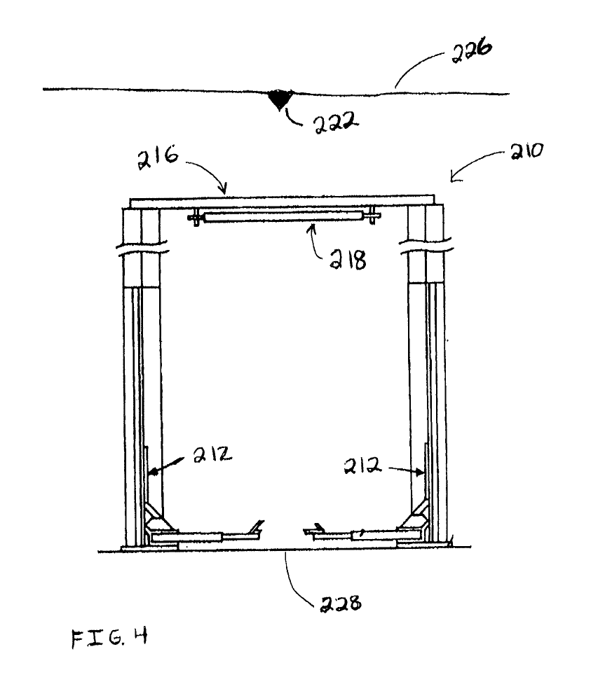

In another merely illustrative alternate version, shown in FIG. 4, a lift system (210) includes a plurality of columns (212) supporting an overhead member (216). The overhead member (216) supports a laser module (218). Additionally, a laser module (222) is positioned on a ceiling (226) above lift system (210). Laser module (218) emits a laser line perpendicular to the sides of a vehicle entering the area between columns (212) in this example. The laser line appears on a ground area (228) between columns (212). Laser module (222) emits a laser line perpendicular to the front and back of a vehicle entering the area between columns (212) in this example. Similar to laser module (218), the laser line emitted appears on the ground area (228) between columns (212). A crosshair (not shown) is produced where both lines intersect one another. The crosshair may be used to identify a position for the vehicle that is suitable for its engagement with lift system (210).

Of course, any suitable laser may be used. For example, a laser emitting a target sign could be used. Similarly, a crosshair produced by a plurality of lasers may be used in any suitable fashion. For example, a vehicle may be deemed to be in a suitable position for engagement with lift system (210) when the crosshair appears in the middle of the vehicle's hood. Likewise, a crosshair produced by intersecting lasers may be configured to appear at the front of the vehicle's hood, on the side of the vehicle, and/or elsewhere, when the vehicle is in a suitable position to properly engage lift system (210).

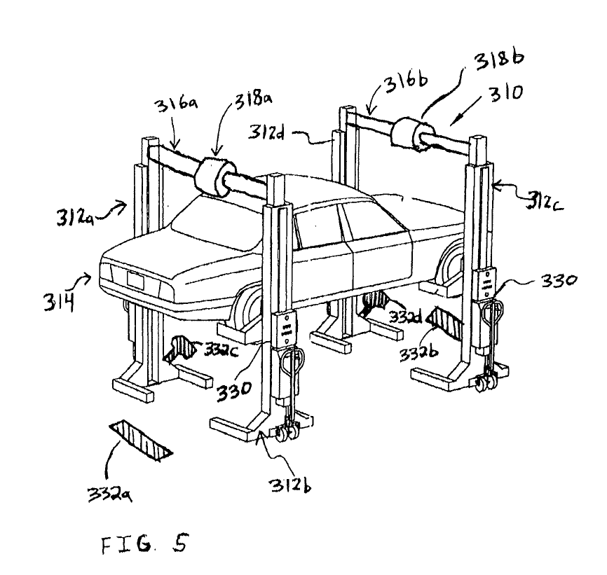

FIG. 5 depicts a lift system (310) including four lift columns (312a, 312b, 312c, 312d). Lift columns (312a, 312b, 312c, 312d) are shown engaged with a vehicle (314). Lift columns (312a, 312b) are engaged with an overhead member (316a). Likewise, lift columns (312c, 312d) are engaged with an overhead member (316b). Laser modules (318a, 318b) are respectively supported by overhead members (316a, 316b).

Laser modules (318a, 318b) may work in conjunction with each other to respectively emit laser beams to produce a crosshair. Alternatively, laser modules (318a, 318b) may emit laser beams that do no intersect with one another (e.g., discrete target symbols, etc.). In the former situation, the crosshair may be used to suitably position vehicle (314) for engagement with lift system (310). In the latter situation, the target symbols may be used independently or in conjunction to suitably position vehicle (314). Of course, any other suitable type of laser configuration may be used.

Various systems may be used to operate the laser modules. These systems may include activation systems for the laser modules. For example, the laser modules described herein may be electrically connected to a user interface (330) for operating lift system (310). In some such versions, user interface (330) has the ability to operate columns (312) and laser modules (318) (e.g., an on/off button or switch for one or more laser modules (318)). In other words, the same user interface (330) that is used to control one or more columns (312) may also be used to control one or more laser modules (318). As another merely illustrative example, a remote control (e.g., handheld, wireless, etc.) may be used to control one or more laser modules (318). Laser modules (318) may thus be selectively activated/de-activated manually, independently relative to each other or collectively, by one or more switches or similar devices. As another merely illustrative example, laser modules (318) may automatically activate as soon as lift system (310) is turned on; or after a predefined time period has passed since lift system (310) was turned on. Alternatively, any other suitable methods may be used to govern the operation and activation of the laser modules. For example, the laser modules may be incorporated into larger control systems for the lifts. Alternatively, the laser modules may be controlled independently by one or more control devices that are separate from the user interface (330) that is used to control lift system (310).

As also shown in FIG. 5, sensors (332) may be used to activate laser modules (318). For example, pressure sensors (332a, 332b) may be located near lift system (310), whereby the movement of a vehicle (314) adjacent pressure sensors (332a, 332b) causes laser modules (318) to begin emitting laser beams. Likewise, photoeye sensors (332c, 332d) may be used. Photoeye sensors (332c, 332d) may be positioned near lift columns (312). Photoeye sensors may activate the lasers upon sensing movement in a designated area. Of course, some lift systems may include pressure sensors (332a, 332b) without also including photoeye sensors (332c, 332d), and vice-versa. In addition or in the alternative, one or more motion sensors and/or proximity sensors may be used to activate and/or de-activate laser modules (318). Alternatively, any other suitable type(s) of sensors in any other suitable location(s) may be used to selectively activate laser modules (318), such as when a vehicle is present near lift system (310) and/or under any other suitable conditions. Still other suitable components, devices, and techniques that may be used to activate laser modules (318) will be apparent to those of ordinary skill in the art in view of the teachings herein.

It should also be understood that laser modules (318) may be de-activated in a variety of ways. For instance, movement of a vehicle (314) away from adjacent pressure sensors (332a, 332b) may cause laser modules (318) to stop emitting laser beams. As another merely illustrative example, passage of a vehicle (314) over a first pressure sensor (332a) associated with the rear of lift system (310) may activate laser modules (318); while passage of a vehicle (314) over a second pressure sensor (332b) associated with the front of lift system (310) may de-activate laser modules (318). In addition or in the alternative, movement of a vehicle (314) away from photoeye sensors (332c, 332d) may cause laser modules (318) to stop emitting laser beams. As yet another merely illustrative example, a simple timer may be used to automatically de-activate laser modules (318) after a certain amount of time has passed. Such a duration may be measured from the time laser modules (318) are activated and/or from the time one or more other events occurred. Still other suitable components, devices, and techniques that may be used to de-activate laser modules (318) will be apparent to those of ordinary skill in the art in view of the teachings herein.

While several of the above examples used to describe how laser modules may be controlled are provided with reference to the example shown in FIG. 5, it should be understood that laser modules may be controlled in the same fashion in any of the other examples of lift systems described herein, including but not limited to the examples shown in FIGS. 1-4, and including any suitable variations of such lift systems.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A vehicle lift system, comprising:
(a) a vehicle lift, wherein the vehicle lift includes one or more lifting members configured to engage a vehicle, wherein the one or more lifting members are operable to selectively raise and lower the vehicle; and
(b) one or more laser modules, wherein the one or more laser modules are operable to emit at least one laser beam configured to provide a visual indicator on a vehicle that is positioned relative to the one or more lifting members.

2. The vehicle lift system of claim 1, wherein the vehicle lift comprises an above-ground lift.

3. The vehicle lift system of claim 2, wherein the one or more lifting members comprise two or more lifting posts.

4. The vehicle lift system of claim 3, wherein the one or more lifting members further comprise one or more lifting arms, wherein each of the one or more lifting arms is pivotally coupled with the one or more lifting posts to selectively engage the vehicle.

5. The vehicle lift system of claim 3, wherein the vehicle lift comprises a collision lift table, wherein the one or more lifting members comprises at least one rack.

6. The vehicle lift system of claim 1, wherein the vehicle lift comprises a below-ground lift.

7. The vehicle lift system of claim 1, wherein the vehicle lift comprises an overhead member coupled with the one or more lifting members.

8. The vehicle lift system of claim 7, wherein the one or more laser modules are coupled with the overhead member.

9. The vehicle lift system of claim 8, wherein the one or more laser modules comprise a first laser module coupled with the overhead member and a second laser module coupled with a ceiling positioned over the vehicle lift.

10. The vehicle lift system of claim 1, wherein the visual indicator comprises a line.

11. The vehicle lift system of claim 10, wherein the visual indicator further comprises a crosshair, wherein the crosshair is defined in part by the line.

12. The vehicle lift system of claim 10, wherein the line is substantially continuous.

13. The vehicle lift system of claim 1, wherein the visual indicator comprises a dot.

14. The vehicle lift system of claim 1, wherein the one or more laser modules comprise:
(i) a first laser module operable to emit a laser beam configured to provide a line on a vehicle positioned relative to the one or more lifting members, and
(ii) a second laser module operable to emit a laser beam configured to provide a dot on the vehicle positioned relative to the one or more lifting members.

15. The vehicle lift system of claim 1, wherein the one or more laser modules are operable to emit a laser beam configured to provide a flashing visual indicator on a vehicle positioned relative to the one or more lifting members.

16. The vehicle lift system of claim 1, wherein the one or more laser modules are operable to emit a green laser beam configured to provide a flashing visual indicator on a vehicle positioned relative to the one or more lifting members.

17. The vehicle lift system of claim 1, further comprising one or more sensors operable to sense the presence of a vehicle proximate to the vehicle lift, wherein the one or more sensors are further operable to at least partially control the one or more laser modules in accordance with the presence of the vehicle proximate to the vehicle lift.

18. The vehicle lift system of claim 17, wherein the one or more sensors are selected from the group consisting of pressure sensors, photoeye sensors, motion sensors, and proximity sensors.

19. A method of positioning a vehicle relative to a vehicle lift, wherein the vehicle lift includes one or more lifting members configured to engage the vehicle, wherein the one or more lifting members are operable to selectively raise and lower the vehicle, the method comprising:
(a) activating one or more laser modules, wherein the one or more laser modules are operable to emit at least one laser beam configured to provide a visual indicator relative to the one or more lifting members;
(b) positioning a vehicle near the one or more lifting members, wherein the laser modules and lifting members are configured such that the visual indicator is provided on the vehicle when the vehicle is positioned near the one or more lifting members; and
(c) viewing the visual indicator on the vehicle to confirm positioning of the vehicle relative to the one or more lifting members.

20. The method of claim 19, wherein the act of activating the one or more laser modules comprises activating a sensor, wherein the sensor is in communication with the one or more laser modules, wherein the sensor is configured to sense the presence of the vehicle relative to the one or more lifting members.
